(19) United States
(12) Patent Application Publication
(10) Pub. No.: US 2003/0108034 A1
(43) Pub. Date: Jun. 12, 2003

(54) System and method for multiplexing transfer paths of network elements based upon packet network

(76) Inventor: Hyun Sang Yu, Seoul (KR)

Correspondence Address: FLESHNER & KIM, LLP, P.O. BOX 221200, CHANTILLY, VA, 20153, US

(21) Appl. No.: 10/309,310

(22) Filed: Dec. 4, 2002

(30) Foreign Application Priority Data
Dec. 4, 2001 (KR) 2001-76109
Oct. 30, 2002 (KR) 2002-66595

(51) Int. Cl. H04L 12/66; H04J 3/16

(52) U.S. Cl. 370/352; 370/469

(57) ABSTRACT

Disclosed is a system and method for multiplexing transport paths of packet network based network elements by implementing a multi-home adaptation layer over the transport layer of a network element. More particularly, the system and method include checking at the multi-home adaptation layer whether any failure occurs on any multi-transport paths connecting a first and second network element; determining if a failure has occurred on a main transport path on which control messages are transmitted, and substituting the main transport path with another multi-transport path on which no failure has occurred.

### BACKGROUND OF THE INVENTION

1. Field of the Invention

The present invention relates to transfer paths of network elements on packet networks, and more particularly to a system and method for multiplexing transfer paths of network elements based upon the packet network.

2. Background of the Related Art

Generally, the next generation communication network for voice or other high speed data communication is structured having different types of networks interoperate based upon packet networks such as the Internet Protocol (IP) or Asynchronous Transfer Mode (ATM) networks. For example, the Public Switched Telephone Network (PSTN) or the Integrated Services Digital Network (ISDN) may be connected to a packet network. Also, as shown in FIG. 1, different types of networks are able to interoperate with one another in open-type communication systems, which are implemented by separating Media Gateways (MGs) in charge of interfacing with each relevant network from Media Gateway Controllers (MGCs), which conduct call process control functions by controlling each of the relevant MGs.

An MG is a gateway responsible for interfacing each network. As shown in FIG. 1, there are different types of MGs, such as, Residential Gateway (RGW), Access Gateway (AGW), and Trunk Gateway (TGW). The RGW is a terminating equipment of a subscriber analog line. The AGW is a terminating equipment of elements located before a PBX Private Branch exchange) or a PSTN exchange such as a subscriber multiplexer. The TGW is a terminating equipment of the trunk line of a local exchange on a PSTN or an N-ISDN.

An MGC, which is an open-type call agent, uses SCTP (Stream Control Transmission Protocol), UDP (User Datagram Protocol), TCP transmission Control Protocol), or SSCOP (Service Specific Connection Oriented Protocol) as a protocol for exchanging control messages with different network elements.

The related art system has various disadvantages. For example, of the above-mentioned protocols, the SCTP, which supports multi-transport paths for interoperation with other network elements by providing multi-home service, is not yet generally used. However, the UDP or the TCP cannot provide services upon any disorder in the communication network because only a single transport path is provided.

Additionally, as with the above-described network elements of the next communication network, various other network elements based upon packet networks use TCP or UDP as a transport layer protocol for exchange of control messages with other network elements. However, in such transport layer protocol used by these various network elements, the problem lies in that only a single transport path is provided in such transport layer protocol and thus the services may not be provided when a failure occurs in the packet network.

The above references are incorporated by reference herein where appropriate for appropriate teachings of additional or alternative details, features and/or technical background.

### SUMMARY OF THE INVENTION

An object of the invention is to solve at least the above problems and/or disadvantages and to provide at least the advantages described hereinafter.

Another object of the present invention is to solve the problem of the related art by multiplexing transport paths of control messages through implementation of a multi-home adaptation layer, which resides in between the application layer and the transfer layer of a packet-based network element.

Another object of the present invention is to provide reliable communication service even if one of the packet networks fails.

Another object of the present invention is distribute a load among multiplexed transfer paths, to make the operation of the network more stable.

Another object of the present invention is to provide a multi-home adaptation layer at the upper portion of a network element's transfer layer, thus making it possible to multiplex transfer paths of control messages through mutually different packet based communication networks.

In order to achieve at least the above objectives in whole or in parts, there is provided a method for multiplexing transport paths of packet network based network elements including (a) implementing a multi-home adaptation layer in between the transport layer and the application layer for multiplexing transport paths; (b) requesting a multi-transport path connection by transmitting its multi-transport addresses according to their priorities to the network element on the other side; (c) receiving multi-transport addresses from the network element on the other side and initializing the connection of the multi-transport paths between the relevant two network elements; and (d) among the initialized multi-transport paths, selecting a main transport path through which control messages will be transmitted and transmitting the control messages to the network element on the other side.

The above method for multiplexing transport paths of packet network based network elements preferably includes (e) checking, at the multi-home adaptation layer, whether any failure occurs on any of the multi-transport paths connecting the network elements; and (f) if a failure has occurred in the main transport path on which the control messages are transmitted, substituting the main transport path with another multi-transport path on which no failure has occurred.

The above method for multiplexing transport paths of packet network based network elements preferably includes (g) substituting the main transport path with another multi-transport path if the upper application layer requests the substitution of the main transport path after the connection of multi-transport paths has been initialized at the multi-home adaptation layer.

Preferably, the substitution of the main transport path is conducted by including address information of a substitute main transport path in a fail-over message, transmitting the address information to the network element on the other side, and receiving a fail-over acknowledgement message from the network element on the other side. Preferably, the transmission of control messages through the selection of the main transport path is conducted by selecting, as the main transport path, a transport address which has the highest priority among the initialized multi-transport paths to the network element on the other side.

Additionally, in order to achieve the objectives, in whole or in parts, there is provided a method for multiplexing transport paths of packet network based network elements including (a) implementing a multi-home adaptation layer in between the transport layer and the application layer for multiplexing transport paths; (b) requesting multi-transport path connection by transmitting its multi-transport addresses to the network element on the other side; (c) receiving multi-transport addresses from the network element on the other side and initializing the connection of the multi-transport paths between the relevant two network elements; and (d) transmitting control messages to the network element on the other side by distributing the control messages to the initialized multi-transport paths.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 illustrates a general structure of a related art open exchange system of the next generation.

FIG. 2 illustrates protocols for relevant layers of a packet network based network element.

FIG. 3 illustrates the structure for transport path multiplexing of network elements based upon the packet network according to the preferred embodiment of the present invention.

FIG. 4 illustrates an implementation of an MHA layer at a network element based upon the packet network according to the preferred embodiment of the present invention.

FIG. 5 illustrates a flow chart illustrating the method for multiplexing transport paths of network elements based upon the packet network according to the preferred embodiment of the present invention.

FIG. 6 illustrates the structure of an MHA message defined for setting up multi-transport paths at the MHA layer and for managing such paths according to the preferred embodiment of the present invention.

FIG. 7 illustrates the structure of set-up messages used at the MHA layer for multi-transport path set-up according to the preferred embodiment of the present invention.

FIG. 8 illustrates the structure of a control message used at the MHA layer according to the preferred embodiment of the present invention.

FIG. 9 illustrates the structure of fail-over messages used at the MHA layer for the substitution of a main transport path according to the preferred embodiment of the present invention.

FIG. 10 illustrates transmission of multi-transport addresses depending on the transport layer protocols according to the preferred embodiment of the present invention.

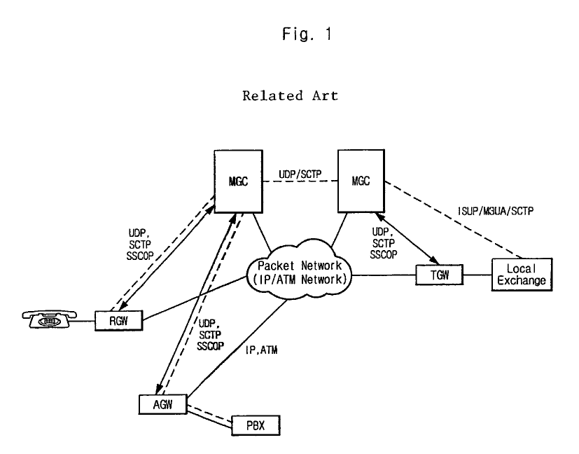

### DETAILED DESCRIPTION OF PREFERRED EMBODIMENTS

Reference will now be made in detail to the preferred embodiments of the present invention, examples of which are illustrated in the accompanying drawings.

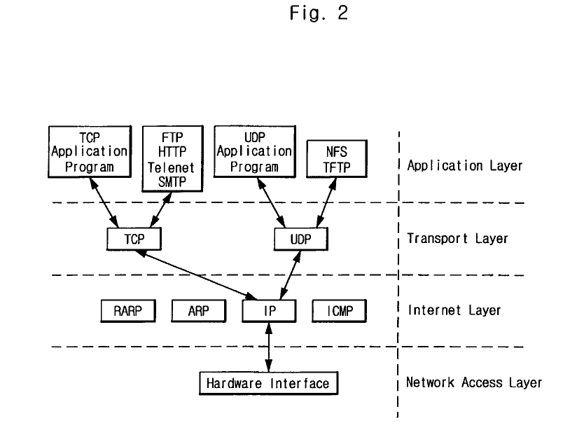

As shown in FIG. 2, the preferred embodiment of the present invention multiplexes transport paths by adding a multi-home adaptation protocol between the transport layer protocols (UDP, TCP, etc.) and the application layer at a packet network based network element. The protocols for the respective layers (composed of the application layer at the top, the transport layer, the Internet layer, and the network access layer) of such a network element based upon the packet network.

The application layer is where network utilities or application programs supported at the relevant network element are provided. The transport layer connects network elements and processes data transmission. The TCP protocol and the UDP protocol are the protocols used for the transport layer.

The Internet layer conducts the function of transporting IP packets between network elements through the datagram method and conducts routing. The network access layer provides the sub-network function, physically transporting IP packets.

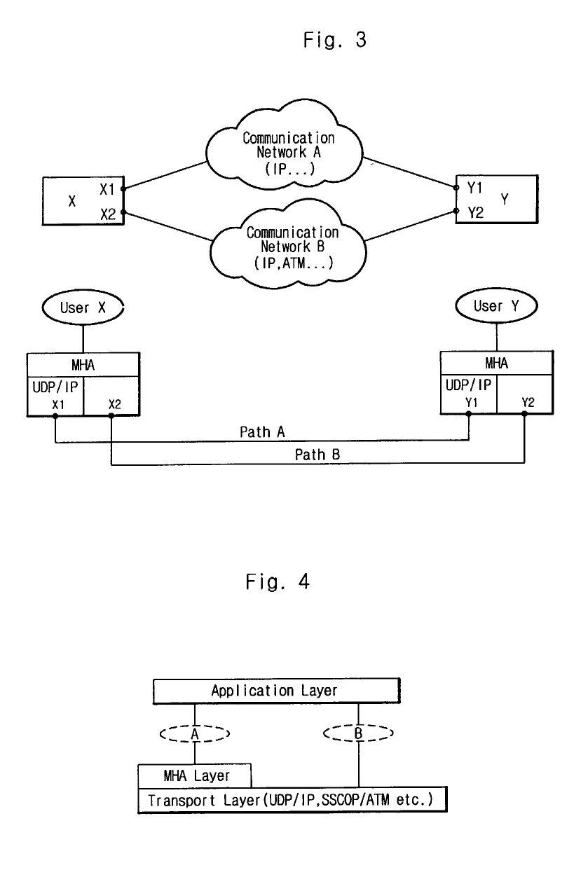

FIG. 3 illustrates the structure of the transport path multiplexing of network elements having the above-described protocol layers according to the preferred embodiment of the present invention. As shown in FIG. 3, there are two different communication networks A and B between network elements X and Y, which are based on the packet network. Also shown are each of the network elements X and Y, which include multi-transport paths through the communication networks A and B, respectively. Also included is the multi-home adaptation (MHA) layer between the UDP/IP transport layer and the application layer, for the main transport set-up and path failure detection function. Next, as shown in FIG. 4, the application layer may not only use the multi-transport paths (A) through the MHA layer, but may also use a single transport path (B) by directly interoperating with the transport layer. The MHA layer sets up or releases multi-transport paths and checks whether the communication is conducted ordinarily on the paths.

Additional information regarding the operation of the MHA layer of the network element X for setting up multi-transport paths to the MHA layer of the network element Y and managing such paths (i.e., the method for multiplexing transport paths for network elements based on the packet network) is next provided.

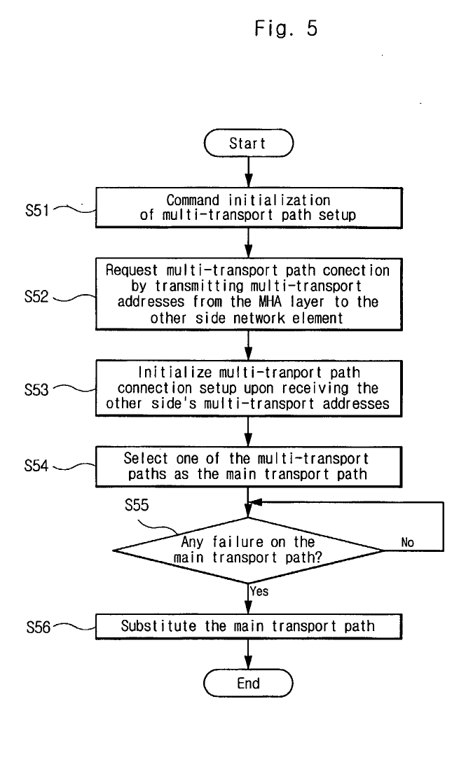

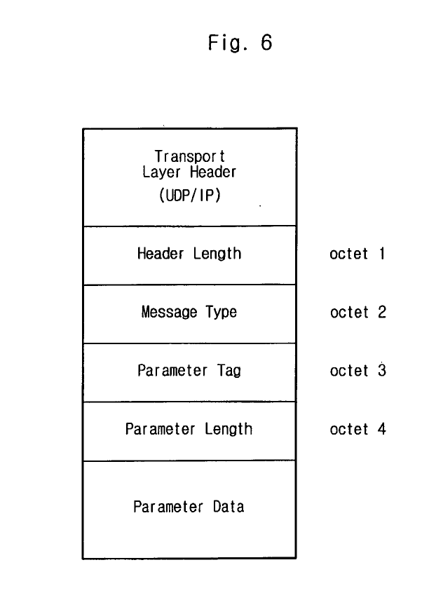

As shown in FIG. 5, in order for an MHA layer described above to set up and manage multi-transport paths, an MHA message (shown in FIG. 6) must be defined first. The MHA message is implemented by using the transport layer header, which is a variable header in the front part of the user data field of a packet network based protocol message.

More specifically, an MHA message preferably includes a transport layer header, a header length information, a message type (kind) information, a parameter tag, a length information, and an actual parameter data. The types of messages may include, a setup message (MH_SETUP, MH_SETUP_ACK) for setting up multi-transport paths; a heartbeat message (MH_HEARTBEAT, MH_HEARTBEAT_ACK) for monitoring the status of the multi-transport paths; fail-over message MH_FAILOVER, MH_FAILOVER_ACK) for notifying the other element of the main transport path's change; and user data message (MH_USER_DATA) for transmitting control messages.

Once the MHA message is defined, as described above, the MHA layer of the network element X and the MHA layer of the other network element Y operate as a master and a slave (Master/Slave relationship) for the set-up and management of multi-transport paths. For example, the application layer of the network element X (the master in charge of setting up and substituting multi-transport paths) issues a command to the MHA layer for initialization of multi-transport path setup with the network element Y by using the multi-transport path setup request primitive, as shown in step S51.

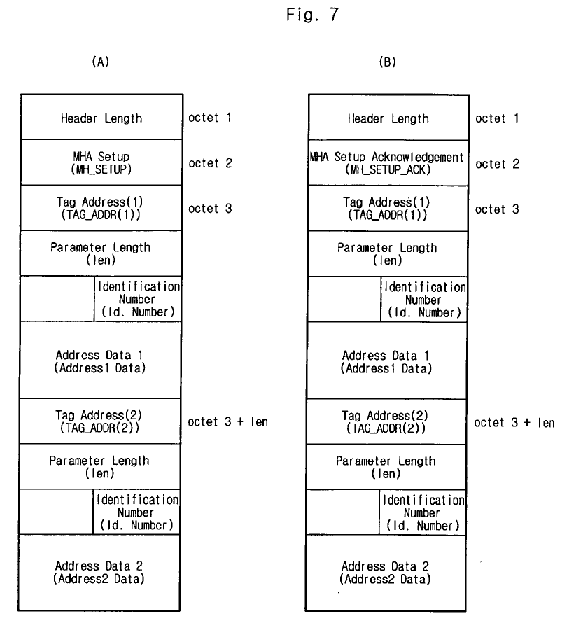

Next, the MHA layer of the network element X (the master) requests the multi-transport path connection by transmitting its multi-transport addresses (X1, X2) to the other network element Y (the slave) and to the pre-defined addresses through the transport layer, as shown in step S52. At this time, an identification number and a priority are given to each of the transport address X1 for one of the multiple transport paths, communication network A, and the transport address X2 for communication network B. Then, by using the MHA setup message, shown in FIG. 7(A), the multi-transport addresses (X1, X2) and their respective identification numbers are transmitted to the network element Y on the other side according to the given priorities.

Conveniently, the MHA layer of the network element Y (the slave) transmits its multi-transport addresses (X1:Y1, X2:Y2) in response to the network element X's request for the multi-transport path connection. Specifically, the transport addresses (Y1, Y2) passing through the communication network A and the communication network B, corresponding to the transport addresses (X1, X2) for which the connection request has been made by the MHA layer of the network element X are transmitted by using an MHA setup acknowledgement message (MH_SETUP_ACK) shown in FIG. 7(B). As with the MHA layer of the network element X, the multi-transport addresses (Y1, Y2) are transmitted together with their respective identification numbers according to the same priorities.

Preferably, the MHA setup message and the MHA setup acknowledgement message (shown in FIGS. 7(A) and (B)) have multiple address parameters for the purpose of transmitting multi-transport address information to the other side. For example, when an MHA setup message is transmitted from the MHA layer of the network element X to the network element Y, if the transport address (X1) passing through the communication network A has a higher priority than the transport address (X2) passing through the communication network B, the address parameter “Address Data 1” contains the address X1 and the address parameter “Address Data 2” contains the address X2 for the transmission. In response, when the MHA layer of the network element Y transmits an MHA setup acknowledgement message to the network element X, “Address Data 1” contains the transport address Y1 passing through the communication network A and “Address Data 2” contains the transport address Y2 passing through the communication network B and then these are transmitted.

Multi-transport address information contained in the address parameters such as “Address Data 1” or “Address Data 2” is an IP address (or port number) if the transport layer protocol is the UDP or the TCP. If any other transport layer protocol were used, the type of the address would change accordingly.

When the MHA layer of the network element X (the master) receives the multi-transport addresses from the MHA layer of the network element Y (the slave) through an MHA setup acknowledgement message for the multi-transport path connection, the connection setup for the multi-transport paths (i.e., path A passing through the communication network A and path B passing through the communication network B) between the network element X and the network element Y is initialized, as shown in Step S53.

As shown in step S54, once the multi-transport path connection setup has been initialized, a multi-transport path is next determined to be the main transport path. Preferably, the main transport path whose transport address has the highest priority among the transport addresses between the network element X and the network element Y is determined to be the main transport path.

Preferably, the network element X and the network element Y store, in their respective internal memories, the transport addresses of the other network element exchanged at the time of setting up the multi-transport path connection and manage them. Further, the network element X and the network element Y remember the previously determined main transport path.

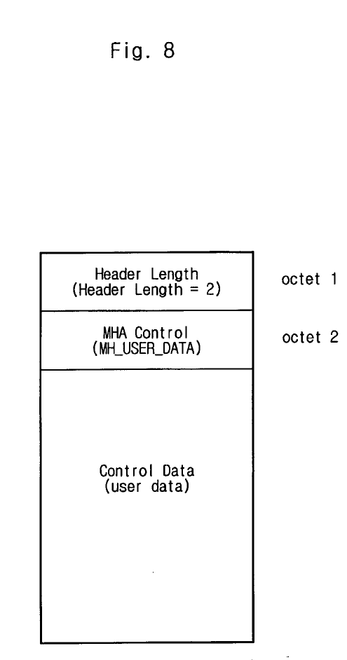

Thereafter, the MHA layer of the network element X transmits control messages to the network element Y by selecting the main transport path through the transport layer. At this time, the user transmits a user message (MH_USER_DATA), which is a control message (shown in FIG. 8) to the MHA layer by using a transport request primitive so that the message may be transmitted to the network element Y. The control message is transmitted by using the same primitive used on the transport layer protocol. For example, if the UDP protocol is used as a transport layer protocol, when the other network element's representative IP address, port number and user message are transmitted to the MHA layer, the MHA layer selects the main transport path corresponding to the transmitted representative IP address and transmits the control message. Thus, the user may transmit control messages to the other side using the UDP primitive, without concerning which transport path is selected by the MHA layer.

While the MHA layer of the network element X transmits control messages to the network element Y, it may also periodically or randomly check the connection status of the multi-transport paths A and B in order to determine whether there is any failure on the main transport path, as shown in step S55. This operation is conducted by transmitting a heart-beat message without any particular parameter from the network element X to the network element Y and then by checking whether an acknowledgement message is received in response thereto. If there is no response after a certain number of trials, it is determined that a failure has occurred on the main transport path. Furthermore, the connection status is checked not only with respect to the main transport path but also with respect to other multi-transport paths.

Alternatively, the checking connection status may be checked by the method of exchanging alive packet messages intended for the connection status check or the method of detecting the connection release or hardware failure at the lower transport layer may be used in order to check the connection status of the multi-transport paths.

If it is determined at step S55 that a failure has occurred on the main transport path, the main transport path is substituted with another multi-transport path, as shown in step S56. At the time of substituting the main transport path, the MHA layer of the network element X (the master) transmits the address information about the new substitute main transport path to the MHA layer of the network element Y. In this manner, the main transport path between the network element X and the network element Y is substituted.

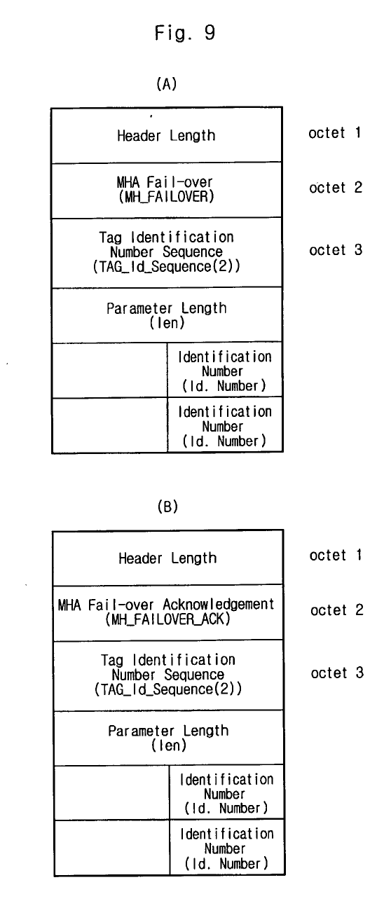

More specifically, if it is determined that the currently used main transport path has a failure, the MHA layer of the network element X transmits the address information about the new substitute main transport path to the MHA layer of the network element Y by using an MHA fail-over message (MH_FAILOVER), as shown in FIG. 9(A). The identification number of such new substitute main transport path is given the highest priority when it is transmitted. Also, the other multi-transport paths are given new priorities.

As shown in FIG. 9(B), the MA layer of the network element Y, which has been informed of the substitution of the main transport path, transmits a fail-over acknowledgement message. Then, the substitution of the main transport path between the network element X and the network element Y is completed.

Additional information regarding the fail-over message and the fail-over acknowledgment message is next provided. As shown in FIGS. 9(A) and (B), the fail-over message and the fail-over acknowledgement message have multiple identification number parameters for transmitting the address information (identification number) of the new substitute main transport path. For example, upon occurring of a failure on a particular main transport path, if the main transport path is to be substituted with the transport address (X1) passing through the communication network A, the first “Identification Number” field of the fail-over message to be transmitted by the MHA layer of the network element X to the network element Y contains “X1,” which is the identification number of the transport path passing through the communication network A. The next “Identification Number” field contains “X2,” which is the identification number of the transport path passing through the communication network B having the next highest priority. Then, when the fail-over message is transmitted, in response thereto, the MHA layer of the network element Y transmits to the network element X a fail-over acknowledgement message whose first “Identification Number” field contains “Y1,” which is the identification number of the transport path passing through the communication network A. The next “Identification Number” field of the fail-over acknowledgement message contains “Y2,” which is the identification number of the transport path passing through the communication network B having the next highest priority.

Additionally, the above-described operation of substituting the main transport path may be conducted not only in a case where a failure occurs on the currently used main transport path, but also in response to a request made by an upper application layer.

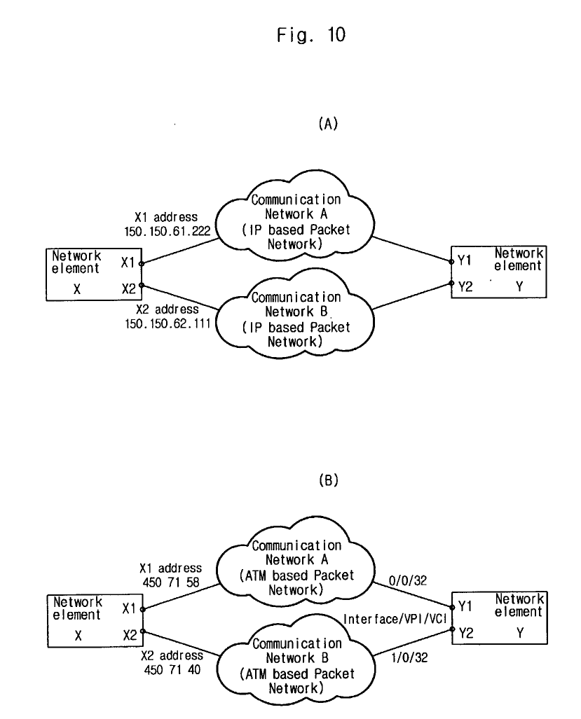

As shown in FIG. 10, in the process of requesting the multi-transport path connection from the MHA layer of the network element X to the MHA layer of the network element Y through the transport layer, if the transport layer uses the UDP or the IP (i.e., if the communication network is an IP based packet network), the MHA layer transmits IP address and port number as the multi-transport address as illustrated in FIG. 10(A). Alternatively, if the transport layer uses the SSCOP (i.e., if the communication network is an ATM based packet network), the MHA layer transmits ATM address, the interface/VPI (Virtual Path Identifier)/VCI (Virtual Channel Identifier), as the multi-transport address.

According to another preferred embodiment of the present invention, the main transport path may not be selected after the initialization of multi-transport path connection. Rather, the control message transmission may be distributed among the multi-transport paths. Further, by checking the connection status of each of the multi-transport paths, if a failure occurs on any of the multi-transport paths, the transport layer may be made to transmit control messages through the other multi-transport paths. Thus, the network may be operated in a stabilized manner.

As described above, the preferred embodiment has many advantages. For example, by multiplexing transport paths for control message transmission through implementing a multi-home adaptation layer between the application layer and the transport layer of a network element based upon the packet network, the preferred embodiment of the present invention accomplishes reliable communication even when one of the packet networks fails. Further, by distributing loads among multi-transport paths, the present invention makes it possible to operate the network in a stabilized manner.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. A method for multiplexing transport paths of first and second elements of a packet based network, comprising:
implementing a multi-home adaptation layer in between a transport layer and an application layer for multiplexing transport paths;
requesting a multi-transport path connection by transmitting a first network element multi-transport address according to a first network element multi-transport address priorities to a second network element; and
receiving a second network element multi-transport address from the second network element and initializing a connection of the multi-transport paths between the first and second network elements.

2. The method of claim 1, further comprising selecting, among the initialized multi-transport paths, a main transport path through which control messages are transmitted and transmitting control messages to the second network element.

3. The method of claim 2, further comprising:
checking, at the multi-home adaptation layer, whether a failure has occured on any of the multi-transport paths connecting the first and second network elements;
determining if a failure has occurred on the main transport path on which the control messages are transmitted; and
substituting the main transport path with another multi-transport path on which no failure has occurred.

4. The method of claim 3, further comprising substituting the main transport path with another multi-transport path if an upper application layer requests the substitution of the main transport path after the connection of multi-transport paths has been initialized at the multi-home adaptation layer.

5. The method of claim 4, wherein the substitution of the main transport path comprises:
including address information of the substitute main transport path in a fail-over message;
transmitting the address information to the second network element; and
receiving a fail-over acknowledgement message from the second network element.

6. The method of claim 3, wherein checking whether the failure has occurred on any of the multi-transport path comprises exchanging a connection status check packet message through the established multi-transport paths.

7. The method of claim 3, wherein checking whether the failure has occurred on any of the multi-transport paths comprises detecting whether there is a disconnection or hardware failure at a lower transport layer.

8. The method of claim 2, wherein transmitting the control messages comprises selecting, as the main transport path, a transport address which has a highest priority among the initialized multi-transport paths to the second network element.

9. The method of claim 1, wherein requesting the multi-transport path connection is conducted if the application layer of the first network element issues to the multi-home adaptation layer a command for multi-transport path setup initialization toward the second network element, by using a multi-transport path setup request primitive.

10. The method of claim 1, wherein requesting the multi-transport path connection comprises:
requesting, at the multi-home adaptation layer, the multi-transport path connection by transmitting the first network element multi-transport addresses including a transport address passing through mutually different communication networks to the second network element by using a set-up message; and
transmitting, at the multi-home adaptation layer of the second network element, the second network element multi-transport addresses corresponding to the transport addresses passing through the different communication networks, which have been received at the time of the multi-transport path connection request, by using a set-up acknowledgement message.

11. A method for multiplexing transport paths of first and second packet network based network elements, comprising:
implementing a multi-home adaptation layer in between a transport layer and an application layer for multiplexing transport paths;
requesting a multi-transport path connection by transmitting a multi-transport address from a first network element to a second network element; and
receiving a multi-transport address from the second network element and initializing the connection of the multi-transport paths between the first and second network elements.

12. The method of claim 11, further comprising transmitting control messages to the second network element by distributing a control message to the initialized multi-transport paths.

13. The method of claim 11, further comprising:
checking, at the multi-home adaptation layer, whether a failure occurs on other multi-transport paths connecting the first and second network elements; and
transmitting control messages if a failure has occurred on one of the multi-transport paths, by distributing the control messages to the other multi-transport paths having no failure.

14. The method of claim 13, wherein checking whether the failure occurs on any of the multi-transport paths comprises exchanging a connection status check packet message through the established multi-transport paths.

15. The method of claim 14, wherein the connection status check packet message is a heart-beat message having no specific parameters.

16. The method of claim 13, wherein checking whether the failure occurs on any of the multi-transport paths comprises detecting whether there is a disconnection or hardware failure at a lower transport layer.

17. The method of claim 11, wherein requesting the multi-transport path connection is conducted if the application layer of the first network element issues to the multi-home adaptation layer a command for the multi-transport path setup initialization toward the second network element, by using a multi-transport path setup request primitive.

18. The method of claim 11, wherein requesting the multi-transport path connection comprises:
requesting, at the multi-home adaptation layer, the multi-transport path connection by transmitting the first and second network element multi-transport addresses, including transport addresses passing through mutually different communication networks, to the second network element by using a set-up message; and
transmitting, at the multi-home adaptation layer of the second network element, the second network element multi-transport addresses corresponding to the transport addresses passing through the different communication networks, which have been received at the time of the multi-transport path connection request, by using a set-up acknowledgement message.

19. The method of claim 15, wherein requesting the multi-transport path connection using a set-up message comprises:
assigning an identification number and a priority to each of the multi-transport addresses; and
recording the multi-transport addresses and the identification numbers in the set-up message and transmitting the set-up message in accordance with the relevant priorities.

20. The method of claim 15, wherein requesting the multi-transport path connection comprises transmitting IP addresses and port numbers as multi-transport addresses if the communication networks, which become the transport paths to the second network element are IP based packet networks or by transmitting an ATM address as multi-transport addresses if the communication networks are the ATM based packet networks.

21. The method of claim 15, wherein the transmission of the multi-transport addresses using a set-up response at the multi-home adaptation layer of the second network comprises recording the second network element multi-transport addresses corresponding to the multi-transport addresses requested by the first network element (connection requesting network element) for connection and their respective identification numbers in a set-up acknowledgement message and transmitting the set-up acknowledgement message to the originating network element according to the same priorities.

22. A system for multiplexing transport paths of first and second packet network based network elements, comprising:
a transport layer configured to connect first and second network elements;
an application layer configured to support network utilities or application programs at the first and second network element;
a multi-home adaptation layer implemented between the transport layer and the application layer for multiplexing transport paths;
first and second network element multi-transport addresses; and
a multi-transport path connection configured to transmit the first network element multi-transport address according to priorities to the second network element, wherein the second network element sends the multi-transport and initializes a connection of the multi-transport paths between the first and second relevant network elements.

23. The system of claim 22, further comprising a main transport path, configured to transmit control messages to the second network element.

24. The system of claim 23, wherein the main transport path is selected from among the initialized multi-transport paths.

25. The system of claim 22, wherein the multi-home adaptation layer is configured to:
check whether a failure has occurred on any of the multi-transport paths connecting the first and second network elements;
determine if a failure has occurred on the main transport path from which the control messages are transmitted; and
substitute the main transport path with another multi-transport path on which no failure has occurred, if the failure has occurred on any of the multi-transport paths.

26. The system of claim 25, wherein the multi-home adaptation layer is configured to substitute the main transport path with another multi-transport path if an upper application layer requests the substitution of the main transport path after the connection of the multi-transport paths has been initialized at the multi-home adaptation layer.

27. The system of claim 25, wherein the multi-home adaptation layer is configured to substitute main transport paths in a fail over message, transmit an address information a second network element, and receive a fail over acknowledgment message from the second network element.
